(19) United States
(12) Patent Application Publication
(10) Pub. No.: US 2004/0146600 A1
(43) Pub. Date: Jul. 29, 2004

(54) Method for preparing savoury-flavoured products by fermentation of proteins

(76) Inventors: Ralf-christian Schlothauer, Emmelsbuell (DE); Tim Carroll, Palmerston (NZ); Graham Peter Davey, Palmerston North (NZ); Jessie Rose Chan, Upper Hutt (NZ)

Correspondence Address: KNOBBE MARTENS OLSON & BEAR LLP, 2040 MAIN STREET, FOURTEENTH FLOOR, IRVINE, CA, 92614, US

(21) Appl. No.: 10/473,711

(22) PCT Filed: Apr. 19, 2002
(86) PCT No.: PCT/NZ02/00067

(30) Foreign Application Priority Data
Apr. 19, 2001 (NZ) 511202

(51) Int. Cl. A23L 1/00

(52) U.S. Cl. 426/7

(57) ABSTRACT

The method of the invention produces a savoury flavoured product from a source of protein using a combination of two distinct strains of bacteria. The source of protein may be a plant soy, wheat or rice- but is preferably milk or whey. The first strain of bacteria is selected from the group Macrococcus, Micrococcus, Entercoccus, Staphylococcus, Brevibacterium, Anthrobacter and Corynebacterium, preferably Macrococcus caseolyticus. The second strain of bacteria is selected from the lactic acid bacteria—Lactococcus, Lactobacillus, Pediococcus or Leuconostoc. The protein source is fermented with the bacteria at a pH above the isoelectric point of the protein, preferably at a pH of 55-6.5. The savoury flavoured product may be combined with other ingredients to form products such as cheese, protein-water gels, yoghurts, creams, custards, sauces and confectionary products.

### TECHNICAL FIELD

This invention relates to a method for preparing a savoury-flavoured product from the fermentation of a source of protein. In one particularly preferred embodiment the invention relates to a savoury-flavoured concentrate made from the fermentation of a milk or milk derivative using food grade bacteria.

### BACKGROUND ART

It is known in the art to ferment a protein based medium with selected lactic acid bacteria The medium may be milk or a milk derivative, although other protein sources may be used. The lactic acid so produced reduces pH, thereby imparting an improved keeping quality. Traditionally the fermentation is carried out under conditions which produce acidic flavours. Examples include cultured milk drinks, yoghurt and soy bean protein products.

It is also known in the art to alter the traditional cheesemaking process to accelerate the development of desired cheese flavours. This reduces the time from production of the cheese to market. The curd produced by enzyme and/or acid-precipitation of milk has a bland flavour until the proteins (and fats) in the curd have been partially hydrolysed. Traditionally these processes may take several months under the action of the residual enzymes or enzyme-expressing bacteria active in the curd. However it is known to accelerate these processes by inoculating cheese slurries or cheese curd with enzyme preparations or microorganisms. In particular, it is known from U.S. Pat. No. 3,689,286 to accelerate the development of cheddar cheese type flavour by inoculating the curd with a strain of Micrococcus bacteria It is also known from U.S. Pat. No. 3,650,768 to make an American-type cheese by inoculating milk with both a strain of Micrococcus bacteria and a lipase enzyme before the addition of a lactic-acid producing cheese-starter bacteria.

It is known to produce cheese flavour by sequentially fermenting a flavour-development medium with a lipase/protease-producing microorganism, followed by a lactic acid bacteria, as described in U.S. Pat. No. 4,675,193.

It is also known to produce savoury flavours by fermentation of vegetable or cereal protein with yeast, moulds and/or bacteria or by enzymatic hydrolysis. In the example of soy sauce, the traditional, time-consuming method is to ferment the protein substrate with a koji mould culture, followed by a bacterial/yeast fermentation in which lactic acid and ethanol are produced. The fermented material is then heated to generate the characteristic colour and flavour (Savoury Flavours, T. W. Nagodawithana, Esteekay Accociates Inc. 1995). The mould fermentation produces enzymes that hydrolyse the protein The traditional process can take several months, but savoury-flavour production can be accelerated by hydrolysing protein using commercial enzyme preparations rather than by fermenting with an enzyme-producing microorganism or to use both commercial enzyme preparations and microorganisms (for example see WO 98/17127 and WO 00/62624).

Fermentation with lactic acid bacteria is also known to impart improved flavour or to accelerate flavour development in meat products, for example as described in U.S. Pat. No. 3,193,391, U.S. Pat. No. 6,063,410 and DE 1692174.

Furthermore, it is known from U.S. Pat. No. 4,001,437 to generate a desired meat flavour from the product of a milk protein-hydrolysis by heating to a temperature above 90° C. However, a meat flavour can be produced without heating by solid fermentation of a plant source of protein with lactic acid bacteria (EP 106236) or a combination of a koji culture with cooked-meat microorganisms (U.S. Pat. No. 6,020,009).

We have discovered that we can produce a savoury-flavoured product in a relative short period of time by fermentation of an aqueous protein-based medium by food-grade bacteria under different conditions from those traditionally used. The product thereby produced may be concentrated to produce a product which may be used as an additive to add flavour to other consumer products such as cheese.

It is an object of this invention to achieve this desideratum or at least to offer the public a useful choice.

### DISCLOSURE OF THE INVENTION

Accordingly, the invention may be said broadly to consist in a method for preparing a savoury-flavoured product from a dairy or vegetable source of protein which comprises:

fermenting said source of protein in a physiologically acceptable aqueous medium containing at least one first food grade strain of bacterium selected from the group consisting of Macroccoccus, Micrococcus, Enterococcus, Staphyloccus, Brevibacterium, Athrobacter and Corynebacterium; and at least one second food grade stain of lactic acid bacterium at a temperature of from 20-42° C. at a pH maintained in excess of the isoelectric point of said medium,

continuing said fermentation until a sufficient degree of hydrolysis has been reached so that said savoury flavour has been achieved and recovering the product so produced, with the proviso that isolated casein or a derivative thereof is not the sole source of protein.

Preferably said first strain is a Macrococcus strain.

More preferably said Macrococcus strain is a strain of Macrococcus caseolyticus. Most preferably said strain of Macrococcus caseolyticus is either of the strains deposited in the American Type Culture Collection under ATCC#51834 and ATCC#51835 [Int J. Syst. Bacteriol. 48:859-877, 1998]. Freeze dried cultures are available for purchase from the ATCC.

Preferably said second strain is selected from the group consisting of a strain of Lactobaccillus, a strain of Lactococcus, a strain of Pediococcus, and a strain of Leuconostoc bacteria.

More preferably said second strain is selected from the group consisting of a strain of L. helveticus, a strain of L. delbrueckii subsp. bulgaricus, a strain of L. delbrueckii subsp. lactis, a strain of L. brevis, a strain of L. paracaseii, a strain of L. rhamnosus and a strain of L. fermentum.

Most preferably said second strain is a strain of Lactobacillus helveticus.

Preferably said sufficient degree of hydrolysis is from 2% to 32%.

More preferably said sufficient degree of hydrolysis is from 4% to 32%.

Most preferably said sufficient degree of hydrolysis is from 7% to 32%.

Preferably said pH is so maintained by the addition of a physiologically acceptable base or buffer.

Preferably said base is potassium hydroxide.

Alternatively said base is sodium hydroxide.

Alternatively said base is calcium hydroxide.

Preferably said source of protein is a milk and/or a milk derivative

Preferably said milk is selected from the group consisting of whole milk, homogenized whole milk, skim milk, reconstituted skim milk powder and reconstituted whole milk powder.

Preferably said milk derivative is selected from the group consisting of milk protein concentrate (MPC), whey protein concentrate (WPC), calcium-depleted milk derivatives, buttermilk, whey and ultrafiltration permeates. Preferably the reconstituted powder or slurry is less than 50% total solids.

Alternatively said source of protein in a physiologically acceptable medium is vegetable or cereal protein.

Preferably said vegetable protein is soy bean protein.

Alternatively said cereal protein is rice or wheat protein.

Preferably said physiologically acceptable medium contains added or native carbohydrate.

In the preferred embodiment said carbohydrate is lactose.

In another embodiment said carbohydrate is glucose, fructose, maltose, sucrose, an oligosaccharide or starch, or a blend of any two or more thereof.

In another embodiment the medium contains cream, cream powder or butter fat.

In a further embodiment the medium contains a non-dairy fat.

Preferably the non-dairy fat is a source of polyunsaturated fatty acid such as olive oil, canola oil or safflower oil.

Alternatively the non-dairy fat is coconut oil.

Preferably the fermentation is conducted at a pH of between 4.0 and 8.0

Most preferably pH is 5.5-6.5

In one embodiment said fermentation is conducted at pH stat conditions.

Preferably the fermentation is conducted at a temperature of 15-45° C.

Most preferably the temperature is 30-40° C.

Preferably said first or second strains of bacteria are added to said medium together.

Alternatively, said first or second strains are added separately at different times, and the temperature and pH at which the fermentation is conducted may be changed after the second or subsequent strains are added.

Preferably the fermentation is continued for from 12 to 96 hours.

Most preferably the fermentation is conducted for about 40-60 hours.

In one embodiment the fermentation is separated into an acid production and a flavour development stage.

In one alternative the pH is changed during said flavour development stage.

In another alternative the temperature is changed during said flavour development stage.

In yet another alternative cells are ruptured to release intracellular enzymes during the flavour development stage.

Preferably the cells are ruptured osmotically by neutralisation of added base.

Alternatively the cells are ruptured by addition of lysosyme.

Alternatively the cells are ruptured by shear.

In a further alternative, hydrolytic enzymes are added in the flavour development stage.

Preferably, lipases or proteases are added.

Alternatively, ruptured cells are added.

In one embodiment growth-enhancing substances are added to the medium.

Preferably protein hydrolysates are added.

In one alternative said fermentation is terminated before said savoury flavoured product is recovered.

Preferably said fermentation is terminated by inactivating said strains of bacteria.

Alternatively said fermentation is terminated by removing said strains of bacteria.

Preferably said strains of bacteria are inactivated by heating.

In another alternative, the microorganisms are harvested and reinoculated into a fresh medium for subsequent flavour development fermentation.

In one embodiment cellular matter from said inactivated strains of bacteria is added to fresh medium for a subsequent flavour development fermentation.

In another embodiment the enzymes that are produced by said strains of bacteria are isolated and added into fresh medium for subsequent flavour development.

In another embodiment enzymes either produced by said strains of bacteria or added for flavour development are deactivated before product recovery.

Preferably said enzymes are deactivated by heating to a minimum temperature of 72° C. for at least 15 minutes.

In one embodiment said recovered flavoured product is concentrated.

Preferably concentration is by drying.

In one alternative the concentration is by evaporation.

Alternatively the concentration is by centrifugation.

Alternatively the concentration is by membrane filtration

In one embodiment the fermented product is heat-treated to develop desired flavours.

In another embodiment the fermented product is aged to develop desired flavours.

In a further embodiment the product is blended with other ingredients to produce the desired final product.

Preferably the desired final product formulation is achieved by blending before concentration.

Alternatively the final product formulation may be achieved by blending the dried product with the desired ingredients.

In one embodiment the fermentation or fermented product is partially desalted.

Preferably desalting is by nanofiltration.

Alternatively desalting is by electrodialysis.

Alternatively microfiltration is performed before electrodialysis.

In another alternative ultrafiltration is performed before electrodialysis.

The invention also includes the additional step of adding the product recovered from the said process to a cheese making process to provide flavour to the cheese to be produced thereby.

In another aspect the invention includes the additional step of adding the product recovered from the said process to a recombined product to provide flavour to the product to be produced thereby.

Preferably said recombined product is selected from the group consisting of protein-water gels, yoghurts, creams, custards, sauces and confectionary products.

In another embodiment the invention may be said to be a savoury-flavoured product produced by the method as defined above.

In a still further embodiment the invention consists in a cheese containing a savoury product as described above.

In another aspect the invention includes a recombined product containing a savoury flavoured product produced by the method as defined above.

In one embodiment said product is provided in the form of a powder.

In another embodiment said product is in the form of a paste

In yet another embodiment said product is in the form of a slurry.

The invention may also be said to consist in a method for preparing a savoury-flavoured product substantially as herein described with reference to any example thereof.

Alternatively the invention consists in a savoury-flavoured product prepared by a method substantially as herein described with reference to any example thereof.

Although the method of the invention claimed contemplates the presence of at least one first strain and one second strain of the identified bacteria it should be understood that strains of other bacteria may be added to the fermentation medium.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWING

The invention may also be understood by having reference to the accompanying drawing wherein:

FIG. 1 is a plot showing the consumption of base by the bacteria against time and the degree of hydrolysis against time for the reaction described below in example 3.

### MODES OF CARRYING OUT THE INVENTION

The invention may be more fully understood by having reference to the following examples.

### EXAMPLE 1

### Savoury Flavour from Whole Milk

Lactobacillus helveticus and Macroccocus caseolyticus were grown overnight at 10L in two separate fermenters of Yeast Glucose Milk, under pH control at 6.1 with ammonium hydroxide neutralization in a milk based medium. 2L of a pasteurised reconstituted whole milk powder was made up to 10% total solids with water and inoculated with 3 mL each of 10⁹ cfu/mL Lactobacillus helveticus and Macroccocus caseolyticus pure cultures at 37° C. The pH was allowed to drop from 6.6 to 6.0 before being maintained at 6.0 by the addition of a 10% KOH solution. The medium was fermented for 48 hours to a degree of hydrolysis of 18% (method as described by H. Frister et al., in Fresenius Zoitschrift Analytik Chimie, 330:631-633, 1988). The fermentation was terminated by adjusting the pH back to 6.6 followed by heating to 60° C. and holding for 30 min. The product was concentrated by freeze-drying. Rice and water crackers coated with olive oil and melted butter were dusted with the freeze-dried product and baked at 100° C. until the powder browned.

A panel of experienced cheese-tasters was convened to devise flavour descriptors for the pre-concentrated product produced by the method described in this example. This was initially done individually, after which a final list of descriptors and their relative intensity was agreed by discussion and consensus. The agreed primary flavour descriptors were savoury, meaty, roast, brothy, mushroom and salty. Products from subsequent examples were compared to this reference example product.

### EXAMPLE 2

### Savoury Flavour from Whole Milk Powder

Lactobacillus helveticus and Macroccocus caseolyticus were grown overnight at 10L in two separate fermenters of Yeast Glucose Milk under pH control at 6.1 with ammonium hydroxide neutralization in a milk based medium. The media of 93 kg of whole milk powder in 930 kg of demineralised water was heated to 54° C. and then partially hydrolysed with 0.5L neutrase for 90 min, after which the enzyme was deactivated by heating to 85° C. The medium was then UHTST-sterilised, cooled to 37° C. and inoculated. The pH was maintained at 6.0 by the addition of a 20L of 49% KOH solution. The pH was then reduced to 4.6 before control at 6.0 was reestablished at 24 hours. A further 8L of 50% KOH was added from 24 to 48 hrs. The fermentation was terminated by heating to 60.5° C. and holding for 30 min. 9 kg of milk protein concentrate was added to 90L of the fermented product to bring the total solids up to 20% and the resulting mixture was spry-dried at an air inlet temperature of 175° C. and an exhaust temperature of 80° C.

Although not tasted by a formal panel, the flavour was comparable to that of example 1.

### EXAMPLE 3

### Savoury Flavour from Skim Milk Powder

An inoculum was prepared as for Example 1. 180 g of a pasteurised reconstituted skim milk powder was made up to 10% total solids with water. 20 mL of 20% lactose solution (0.45 μm filtered) was added. The medium was inoculated with 3 mL each of 10⁹ cfu/mL Lactobacillus helveticus and Macroccocus caseolyticus pure cultures at 37° C. The pH was allowed to drop from 6.6 to 6.0 before being maintained at 6.0 for the fermentation by the addition of a 10% KOH solution. The medium was fermented for 40 hours to a degree of hydrolysis of 5%. The fermentation was terminated by adjusting the pH back to 6.6 followed by heating to 60° C. and holding for 30 min. The savoury flavour was less intense than from Example 1, although strong brothy and roast notes were evident.

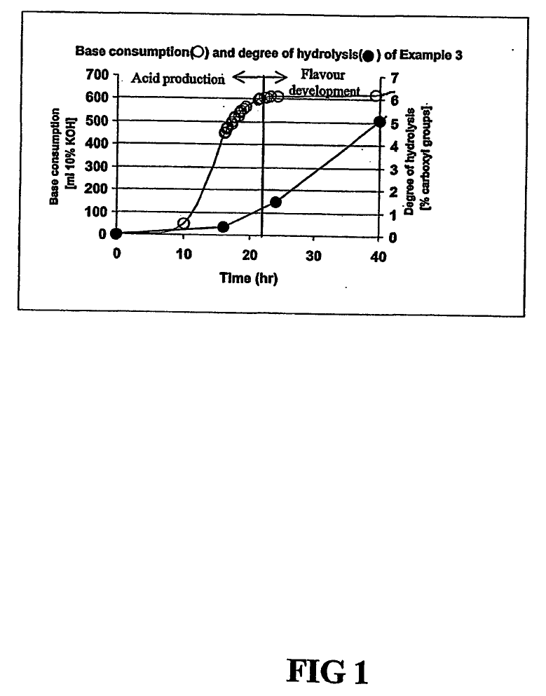

The line plotted by the circles in FIG. 1 shows the activity of the combined cultures of Lactobacillus helveticus and Macroccocus caseolyticus. Over the first 24 hours of the fermentation, the cultures are actively growing, consuming lactose and producing lactic acid, which is neutralised to salt by adding base (termed the acid production stage). The open symbols show the base consumption over time. Eventually after sufficient lactose consumption and salt production, growth becomes inhibited, cell numbers stop increasing and the enzymes they produce hydrolyse the proteins to produce the desired flavour substances (termed the flavour development stage). The solid symbols show the degree of hydrolysis over time.

### EXAMPLE 4

### Savoury Flavour from Whey Protein Concentrate

An inoculum was prepared as for Example 1. 2L of a pasteurised whey protein concentrate solution was made up as 10% whey protein concentrate and 3% lactose in water and the medium was inoculated with 3 mL each of 10⁹ cfu/mL Lactobacillus helveticus and Macroccocus caseolyticus pure cultures at 37° C. The medium was fermented for 40 hours to a degree of hydrolysis of 4.6%. The pH was maintained at 6.0 for the fermentation by the addition of a 10% KOH solution. The fermentation was terminated by adjusting the pH back to 7.0 followed by heating to 60° C. and holding for 30 min.

The flavour was relatively musty with a moderately brothy note.

### EXAMPLE 5

### Savoury Flavour from Soy Protein Isolate

2L of acid whey was made up to 10% total solids with soy protein isolate. An inoculum was prepared as for Example 1. The medium was heated to 37° C. and inoculated with 3 mL each of 10⁹ cell/mL Lactobacillus helveticus and Macroccocus caseolyticus pure cultures. The medium was fermented for 48 hours. The pH was allowed to drop from 6.6 to 6.0 before being maintained at 6.0 for the fermentation by the addition of a 10% KOH solution. The fermentation was terminated by heating to 60° C. and holding for 30 min. The flavour was both savoury and cereal.

### EXAMPLE 6

### Savoury Flavour from Whole Milk Powder

An inoculum was prepared as for Example 1. 2L of a pasteurised reconstituted whole milk powder was made up to 10% total solids with water and inoculated with 3 mL each of 10⁹ cfu/mL Lactobacillus helveticus and Macroccocus caseolyticus pure cultures at 37° C. The medium was fermented for 24 hours to a degree of hydrolysis of 20%. The pH was allowed to drop from 6.6 to 6.0 before being maintained at 6.0 by the addition of a 1.0% KOH solution. 10 g of lysozyme was added to the medium after 24 hours and the pH was thereafter maintained at 5.2. The fermentation was terminated by adjusting the pH back to 6.6 followed by heating to 60° C. and holding for 30 min.

The flavour was similar to that of Example 1, although the roast note was more subdued, and a stronger mushroom note was evident.

### EXAMPLE 7

### Fermentation with Only One Bacterium from First Group (Control Example)

An inoculum was prepared as for Example 1. 2L of a pasteurised reconstituted skim milk powder was made up to 10% total solids with water. The medium was inoculated with 3 mL of 10⁹ cfu/mL Macrococcus caseolyticus culture at 37° C. The pH was allowed to drop from, 6.6 to 6.0 before being maintained at 6.0 for the fermentation by the addition of a 10% KOH solution. The medium was fermented for 47 hours to a degree of hydrolysis of 5.5%. The fermentation was terminated by adjusting the pH back to 6.6 followed by heating to 60° C. and holding for 30 min.

This fermentation produced undesirable off-flavours that were considerably different from the earlier examples.

### EXAMPLE 8

### Fermentation with Only One Bacterium from Second Group (Control-Example)

An inoculum was prepared as for Example 1. 2L of a pasteurised reconstituted skim milk powder was made up to 10% total solids with water. The medium was inoculated with 3 mL of 10⁹ cfu/mL Lactobacillus helveticus culture at 37° C. The pH was allowed to drop from 6.6 to 6.0 before being maintained at 6.0 for the fermentation by the addition of a 10% KOH solution. The medium was fermented for 49 hours to a degree of hydrolysis of 8.8%. The fermentation was terminated by adjusting the pH back to 6.6 followed by heating to 60° C. and holding for 30 min.

The flavour was significantly different from those produced in Examples 1-6. The Lactobacillus helveticus alone produced an acidic and sour flavour that was substantially less savoury than that of Example 1.

### EXAMPLE 9

### Fermentation of Unsuitable Protein Substrate (Control Example)

The inoculum was prepared as for Example 1. 2L of a pasteurised calcium caseinate solution was made up to 10% total solids with water. 3% lactose was added and the medium was inoculated with 3 mL each of 10⁹ cfu/mL Lactobacillus helveticus and Macroccocus caseolyticus pure cultures at 37° C. The medium was fermented for 40 hours to a degree of hydrolysis of 2.5%. The pH was maintained at 6.0 for the fermentation by the addition of a 10% KOH solution. The fermentation was terminated by adjusting the pH back to 7.0 followed by heating to 60° C. and holding for 30 min.

This product was intensely bitter in flavour.

### EXAMPLE 10

### Savoury Flavour from Whole Milk Powder with Three Bacterial Strains

2L of a pasteurised reconstituted whole milk powder was made up to 10% total solids with water. The medium was inoculated with 3 mL each of 10⁹ cfu/mL Lactobacillus bulgaricus, Enterococcus faecalis (EFT) and Macrococcus caseolyticus strains at 37° C. The medium was fermented for 48 hours. The pH was allowed to drop from 6.6 to 6.0 before being maintained at 6.0 for the fermentation by the addition of a 10% KOH solution. The fermentation was terminated by adjusting the pH back to 6.6 followed by heating to 60° C. and holding for 30 min.

This product had a cheese flavour, although considerably less savoury flavour than that of Example 1.

### EXAMPLE 11

### Savoury Flavour from Whole Milk Powder with Added Enzyme

An inoculum was prepared as for Example 1. 2L of a pasteurised reconstituted whole milk powder was made up to 10% total solids with water and inoculated with 3 mL each of 10⁹ cfu/mL Lactobacillus helveticus and Macroccocus caseolyticus pure cultures at 37° C. The pH was allowed to drop from 6.6 to 6.0 before being maintained at 6.0 for the fermentation by the addition of a 10% KOH solution. The medium was fermented for 24 hours after which 500 mLs was removed, and 0.1% Palatase™ enzyme and ethanol (to 0.1M) were added. The fermentation was then continued for a further 24 hours.

This product had a savoury and soapy flavour.

### EXAMPLE 12

### Savoury Flavour from Pasteurised Whole Milk

The inoculum was prepared as for Example 1. 2L of pasteurised whole milk was inoculated with 3 mL each of 10⁹ cfu/mL Lactobacillus helveticus and Macroccocus caseolyticus pure cultures at 37° C. The pH was allowed to drop from 6.6 to 6.0 before being maintained at 6.0 for the fermentation by the addition of a 10% KOH solution. The fermentation was terminated after 48 hours.

This product was similar in flavour to that of Example 1, although the savoury note was slightly less intense.

### EXAMPLE 13

### Savoury Flavour from Whole Milk Using ATCC Strain #51834

Lactobacillus helveticus was prepared as described in Example 1. Macroccocus caseolyticus (ATCC#51834) was grown in 10% reconstituted slim milk at 37° C. for 16-18 hours. 2L of a pasteurised reconstituted whole milk powder was made up to 10% total solids with water and inoculated with 3 mL of approximately 10⁹ cfu/mL Lactobacillus helveticus, and approximately 8-16 mL of Macroccocus caseolyticus pure cultures at 37° C. The pH was allowed to drop from 6.6 to 6.0 before being maintained at 6.0 by the addition of a 10% KOH solution. The medium was fermented for 48 hours. The fermentation was terminated by heating to 60° C. and holding for 30 min.

This product was similar in flavour to Example 1, although the savoury flavour was less intense, and the mushroom flavour was more intense.

### EXAMPLE 14

### Savoury Flavour from Whole Milk Using ATCC Strain #51835

Lactobacillus helveticus was prepared as described in Example 1. Macroccocus caseolyticus (ATCC#51834) was grown in 10% reconstituted skim milk at 37° C. for 16-18 hours. 2L of a pasteurised reconstituted whole milk powder was made up to 10% total solids with water and inoculated with 3 mL of approximately 10⁹ cfu/mL Lactobacillus helveticus, and approximately 8-16 mL of Macroccocus caseolyticus pure cultures at 37° C. The pH was allowed to drop from 6.6 to 6.0 before being maintained at 6.0 by the addition of a 10% KOH solution. The medium was fermented for 48 hours. The fermentation was terminated by heating to 60° C. and holding for 30 min.

This product was very close in flavour to Example 1.

### Additional Comments

The strong tendency of casein protein to form bitter-tasting protein hydrolysates is well known, and nearly all of the development work on casein hydrolysis processes has centred around the bitterness problem [J. Adler-Nissen,. Enzymatic Hydrolysis of Food Proteins, Elsevier, 1986 and references therein]. It was not surprising that an isolated caseinate fermented as described by the process of the invention produced an intensely bitter flavour and no savoury notes as described by the panel Example 9). However it was surprising that bitterness was avoided when the other protein substrates containing at least some casein were fermented by the same method.

The savoury-flavoured product produced as described has the advantage over existing processes in that a heating step is not required for flavour development, and the flavour can be produced in a relatively short period of time without the use of commercial enzyme preparations.

The degree of hydrolysis at which the desired savoury flavour is achieved depends upon the chosen protein substrate and fermentation process parameters, for example, time, temperature and concentration of substrate.

Examples 1 to 6 and 10 to 14 describe preferred modes of putting the invention into practice. Protein sources, strains of bacteria and fermentation conditions which are alternatives to those exemplified will be known to those skilled in the art or can be readily determined. The scope of the invention is not limited by the examples but is defined by the appended claims.

1. A method for preparing a savoury-flavoured product from a dairy or vegetable source of protein which comprises:
fermenting said source of protein in a physiologically acceptable aqueous medium containing at least one first food grade strain of bacterium selected from the group consisting of Macrococcus, Micrococcus, Enterococcus, Staphyloccus, Brevibacterium, Anthrobacter and Corynebacterium; and at least one second food grade strain of lactic acid bacterium at a temperature of from 20-42° C. at a pH maintained in excess of the isoelectric point of said medium,
continuing said fermentation until a sufficient degree of hydrolysis has been reached so that said savoury flavour has been achieved and recovering the product so produced, with the proviso that isolated casein or a derivative thereof is not the sole source of protein.

2. A method as claimed in claim 1 wherein said first stain is a Macrococcus strain.

3. A method as claimed in claim 2 wherein said Macrococcus strain is a strain of Macrococcus caseolyticus.

4. A method as claimed in clam 3 wherein said strain of Macrococcus caseolyticus is either of the strains deposited in the American Type Culture Collection under ATCC#51834 and ATCC#51835.

5. A method as claimed in any one of the preceding claims wherein said second strain is selected from the group consisting of a strain of Lactobaccillus, a strain of Lactococcus, a strain of Pediococcus, and a stain of Leuconostoc bacteria.

6. A method as claimed in claim 5 wherein said second stain is selected from tie group consisting of a strain of L, helveticus, a strain of L. delbrueckii subsp. bulgaricus, a stain of L. delbrueckii subsp. lactis, a strain of L. brevis, a strain of L. paracaseii, a strain of L. rhamnosus and a strain of L. fermentum.

7. A method as claimed in claim 5 wherein said second strain is a strain of Lactobacillus helveticus.

8. A method as claimed in any one of the preceding claims wherein said sufficient degree of hydrolysis is from 20% to 32%.

9. A method as claimed in claim 8 wherein said sufficient degree of hydrolysis is from 4% to 32%.

10. A method as claimed in claim 8 wherein said sufficient degree of hydrolysis is from 7% to 32%.

11. A method as claimed in any one of the preceding claims wherein said pH is so maintained by the addition of a physiologically acceptable base or buffer.

12. A method as claimed in any one of the preceding claims wherein said source of protein is a milk and/or a milk derivative.

13. A method as claimed in claim 12 wherein said milk is selected from the group consisting of whole milk, homogenised whole milk, skim milk; reconstituted skim milk powder and reconstituted whole milk powder.

14. A method as claimed in claim 12 wherein said milk derivative is selected from the group consisting of milk protein concentrate (MPC), whey protein concentrate (WPC), calcium-depleted milk derivatives, buttermilk, whey and ultrafiltration permeates.

15. A method as claimed in any one of claims 1 to 11 wherein said source of protein is vegetable or cereal protein.

16. A method as claimed in claim 15 wherein said vegetable protein is soy bean protein.

17. A method as claimed in claim 16 wherein said cereal protein is rice or wheat protein.

18. A method as claimed in any one of the preceding claims wherein said physiologically acceptable medium contains added or native carbohydrate.

19. A method as claimed in claim 18 wherein said carbohydrate is lactose.

20. A method as claimed in claim 18 wherein said carbohydrate is selected from the group consisting of glucose, fructose, maltose, sucrose, an oligosaccharide and starch or a blend of any two or more thereof.

21. A method as claimed in any one of the preceding claims wherein said medium contains cream, cream powder or butter fat.

22. A method as claimed in any one of claims 1 to 20 wherein said medium contains a non-dairy fat.

23. A method as claimed in claim 22 wherein said non-dairy fat is coconut oil.

24. A method as claimed in claim 22 wherein said non-dairy fat is a source of polyunsaturated fatty acid.

25. A method as claimed in claim 24 wherein said source of polyunsaturated fatty acid is selected from the group consisting of olive oil, canola oil and safflower oil.

26. A method as claimed in any one of the preceding claims wherein said fermentation is conducted at a pH of between 4.0 and 8.0.

27. A method as claimed in claim 26 wherein said pH is 5.5-6.5.

28. A method as claimed in any one of the preceding claims wherein said fermentation is conducted at pH stat conditions.

29. A method as claimed in any one of the preceding claims wherein said fermentation is conducted at a temperature of 15-45° C.

30. A method as claimed in claim 29 wherein said temperature is 30-40° C.

31. A method as claimed in any one of the preceding claims wherein said first and second strains of bacteria are added to said medium together.

32. A method as claimed in any one of claims 1 to 30 wherein said first and second strains of bacteria are added at different times, and the temperature and pH at which the fermentation is conducted may optionally be changed after the second or subsequent strains are added.

33. A method as claimed in any one of the preceding claims wherein said fermentation is continued for from 12 to 96 hours.

34. A method as claimed in claim 33 wherein said fermentation is conducted for about 40-60 hours.

35. A method as claimed in any one of the preceding claims wherein said fermentation is separated into an acid production and a flavour development stage.

36. A method as claimed in claim 35 wherein the pH is changed during the flavour development stage.

37. A method as claimed in claim 35 or claim 36 wherein the temperature is changed during the flavour development stage.

38. A method as claimed in any one of claims 35 to 37 wherein cells of said strains of bacteria are ruptured to release intracellular enzymes to initiate the flavour development stage.

39. A method as claimed in any one of claims 35 to 37 wherein hydrolytic enzymes are added in said flavour development stage.

40. A method as claimed in claim 39 wherein said hydrolytic enzymes are lipases or proteases.

41. A method as claimed in any one of the preceding claims wherein said fermentation is terminated before said savoury flavoured product is recovered.

42. A method as claimed in any one of the preceding claims wherein said first and second strains of bacteria are harvested and reinoculated into a fresh medium for a subsequent flavour development fermentation.

43. A method as claimed in any one of claims 1 to 41 wherein enzymes produced from said strains of bacteria are recovered and added into fresh medium for subsequent flavour development.

44. A method as claimed in any one of the preceding claims wherein enzymes either produced by said strains of bacteria or added for flavour development are deactivated before product recovery.

45. A method as claimed in claim 44 wherein said enzymes are deactivated by heating to a temperature of at least 72° C. for at least 15 minutes.

46. A method as claimed in any one of the preceding claims wherein said flavoured product is concentrated.

47. A method as claimed in any one of the preceding claims wherein said fermentation product is heat-treated to develop desired flavours.

48. A method as claimed in any one of the preceding claims wherein said fermentation product is partially desalted.

49. A method as claimed in any one of the preceding claims wherein said fermentation product is blended with other ingredients to produce a final product.

50. A method claimed in any one of the preceding claims which includes the additional step of adding the product recovered from the said process to a cheese making process to provide flavour to the cheese to be produced thereby.

51. A method claimed in any one of claims 1 to 49 which includes the additional step of adding the product recovered from the said process to a recombined product to provide flavour to the product to be produced thereby.

52. A method as claimed in claim 51 wherein said recombined product is selected from the group consisting of protein-water gels, yoghurts, creams, custards, sauces and confectionary products.

53. A savoury flavoured product prepared by a process according to any one of claims 1 to 48.

54. A final product containing a savoury flavoured product as claimed in claim 53.

55. A cheese containing a savoury flavoured product as claimed in claim 53.

56. A recombined product containing a savoury flavoured product as claimed in claim 53.
